(19) United States
(12) Patent Application Publication
(10) Pub. No.: US 2018/0120508 A1
(43) Pub. Date: May 3, 2018

(54) OPTICAL MULTIPLEXER OR DE-MULTIPLEXER FOR USE IN OPTICAL MODULES

(71) Applicant: MACOM Technology Solutions Holdings, Inc., Lowell, MA (US)

(72) Inventor: Nan Xie, Tokyo (JP)

(21) Appl. No.: 15/795,154

(22) Filed: Oct. 26, 2017

Related U.S. Application Data
(60) Provisional application No. 62/495,595, filed on Oct. 27, 2016.

(51) Int. Cl. G02B 6/293

(52) U.S. Cl. CPC G02B 6/2938

(57) ABSTRACT

An optical multiplexer having two or more optic elements with optic coating or layers that act as optic filters. The optic elements are configured to receive optic signals and the coating on the optic elements allow certain wavelengths to pass therethrough while other frequencies are reflected. One configuration includes a first, second, third and fourth optic elements or substrates which are configured to combine four optic signals into a reduced number, such as a single combined signal. Coatings are placed between the optic elements such that each coating is a type of filter that reflects or allows passage of certain frequencies. At least one coating is selected to reflect an optic signal while the other coatings are selected to selectively reflect or pass optic signals (beams) based on the wavelength of the optic signal and the coating.

### RELATED APPLICATIONS

### 1. Priority Claim

This application is a continuation of and claims priority to U.S. Prov. Appl. No. 62/495,595 filed on Oct. 27, 2017 which application is expressly incorporated by reference herein.

### 2. Field of the Invention

The invention relates to optical communication devices, and in particular to optical multiplexers.

### 3. Related Art

To increase data bandwidth and data communication rates over fiber optic fibers it is known to combine two or more data channels on to a single fiber. These types of prior art systems are shown in FIG. 1A and FIG. 1B, both of which are described together as an example environment of use and the prior art optical multiplexer. As shown in FIG. 1A, a circuit board 104 with one or more electrical components is shown thereon. A data signal is provided to a driver amplifier 108. One or more connectors or traces 110 may provide the electrical signals to a housing containing the optical components. This housing unit may be referred to as a TOSA (transmission optical sub-assembly).

The driver amplifier 108 amplifies and provides the data signal to an LED or Laser 112 which in turn converts two or more electrical signals to two or more optical signals. The resulting optical signals are focused by a lens array 116 toward an optical multiplexer (OMUX) 120. The OMUX 120 combines two or more optic signals into a single combined optic signal suitable for transmission over an optic fiber. The combined optic signal is focused by a lens 124 to a fiber optic cable 128.

In the prior art, the OMUX was typically either a multiple reflection design or a PLC (planar lightwave circuit) technology. The multi-reflection design is shown in FIGS. 1A and 1B. This design derives its name from the zig-zag path 130 that the light is forced to take as it undergoes numerous reflections. As shown in FIG. 1B, typical embodiments of a TOSA that utilize the prior art multiple reflection design are typically sized at about 15 mm. This size is larger than preferred. In addition, the multi-reflection light path results in numerous reflections, which are undesirable because each reflection results in misalignment of the optic signals, which in turn corrupts optic signal combination and power level consistency. In addition, the light path through the multi-reflection path OMUX extends the light path and number of reflections which will degrade signal quality and magnitude. This prior art approach suffers from numerous other drawbacks including costs, footprint, light beam alignment challenges, and attenuation.

Another prior art option is PLC (planar lightwave circuit) technology, also known as photonic integrated circuits or integrated optoelectronic devices, which are devices on which several or even many optical (and often also electronic) components are integrated. The technology of such devices is called integrated optics. Photonic integrated circuits are usually fabricated with a wafer-scale technology (involving lithography) on substrates (often called chips) of silicon, silica, or a nonlinear crystal material such as lithium niobate (LiNbO3). The substrate material already determines a number of features and limitations of the technology. While PLC technology can be used to combine two or more optic signals into a single optic signal, existing PLC devices are undesirably large in size and can be costly. For example, a typical PLC based OMUX has a size of about 4.5 mm by 9 mm, and as such it is too large for many applications, and has a cost factor that is several times more than other approaches.

### SUMMARY

To overcome the drawbacks with the prior art and provide additional benefits, an optical multiplexer is disclosed which is even more compact, more accurate, and more cost effective than prior art optical multiplexers. In one embodiment, the optical multiplexer includes a first optic element configured to receive a first optic signal and a first filter on the first optic element configured to reflect the first optic signal. Also, part of this embodiment is a second optic element configured to receive a second optic signal. A second filter is between the first optic element and the second optic element and this second coating is configured to allow the first optic signal to pass the while reflecting the second optic signal. A third optic element is configured to receive a third optic signal and a third filter between the second optic element and the third optic element. The third filter is configured to allow the first optic signal and the second optic signal to pass while reflecting the third optic signal. Also part of this embodiment is a fourth optic element, configured to receive a fourth optic signal and a fourth filter between the third optic element and the fourth optic element. The fourth filter is configured to allow the fourth optic signal to pass while reflecting the first optic signal, second optic signal, and third optic signal. The terms first, second, third and fourth may correspond to the lanes or optic beams. Although shown with four optic elements and four optic signals, it is contemplated that any number of lanes, optic elements, and optic signals may be in the system and that the resulting system may utilized the novel features disclosed herein.

In one embodiment, the optic elements are glass and the first optic element is adjacent the second optic element, the second optic element is adjacent the third optic element and the third optic element is adjacent the fourth optic element. The first filter, second filter, and third filter may be configured to reflect the respective first optic signal, second optic signal and third optic signal at 45 degrees incident to the filter, i.e. relative to the surface of the filter, which is an angle of 45 degrees relative (with respect to) to the optic signal (beam). The beam is reflected at an angle of 90 degrees relative to the original path of the beam. The terms beam and optic signal are used interchangeably herein. In one variation, the first filter, second filter, third filter and fourth filter are wavelength specific filters which are configured to pass certain light and reflect other wavelengths. It is contemplated that the fourth optic element and fourth filter combine the first optic signal, second optic signal and third optic signal, and fourth optic signal into a combined optic signal which exits the third optic element or the fourth optic element. In one embodiment the first optic element, the second optic element and the third optic element are parallelogram shaped and the fourth optic element is triangle shaped.

Also disclosed is an optical multiplexer comprising a first optic element configured to receive a first optic signal and one or more first coatings on or in the path of the first optic signal such that the one or more first coatings are configured to reflect the first optic signal. Also part of this multiplexer is a second optic element configured to receive a second optic signal and the first optic signal. One or more second coatings are located between the first optic element and the second optic element such that the one or more second coatings are configured to allow the first optic signal to pass therethrough while reflecting the second optic signal. The first optic signal and the second optic signal overlap to create a combined optic signal. As used herein the term ‘one or more coatings’ may be a single coating, such as a thin film filter type coating, or multiple coatings or layers.

In one variation, the optical multiplexer further comprises a third optic element configured to receive a third optic signal and a one or more third coatings between the second optic element and the third optic element. The one or more third coatings are configured to allow the first optic signal and the second optic signal to pass therethrough, while reflecting the third optic signal. The first optic signal, the second optic signal, and the third optic signal overlap to create the combined optic signal.

In another embodiment, the optical multiplexer further comprises an additional optic element configured to receive an additional optic signal and a one or more additional coatings between the third optic element and the additional optic element. The one or more additional coatings are configured to allow the additional optic signal to pass while reflecting the first, second, and third optic signals out of the multiplexer. The first optic signal, the second optic signal, the third optic signal, and the additional optic signal overlap to create the combined optic signal.

The step of reflecting the first, second, and third optic signals reflects the first, second, and third optic signals at 90 degrees relative to an original beam path prior to reflection. The reflection angle may also be described as 45 degrees incident to the coating. In one embodiment, the angle of reflection is 45 degrees relative (with respect to) to the reflective coating. The signal may be referred to as a beam. It is contemplated that the one or more first coatings result in a reflective type coating that reflect the first optic signal, and the one or more second coatings result in a passing of the first optic signal while reflecting the second optic signal. Thus, this second coating passes one or more wavelengths and reflects one or more wavelengths. In another embodiment, the second coating could be a high pass coating, such as if the reflected first optic signal is a higher wavelength than the second optic signal. The optic elements may be formed from glass. The multiplexer may further comprise or be configured to direct the optic signal to a fiber optic cable that is configured to receive the combined signal. One or more optic signal generators may be provided and configured to generate the first optic signal and the second optic signal. All the coatings or filters disclosed herein may be one or more coating or filters such that the performance of the coating and filter is as described herein.

Also disclosed is a method for performing optical multiplexing. In one embodiment, this method includes providing a first optic element and a second optic element and receiving a first optic signal through a first side of the first optic element. Then reflecting the first optic signal from a coating toward the second optic element and receiving a second optic signal through a first side of the second optic element. The second optic element receives both the first and second optic signals, such as through a second side of the second optic element. This method then reflects the second optic signal from a second coating while allowing the first optic signal to pass through the second coating into the second optic element to thereby combine the first optic signal and the second optic signal into a combined optic signal.

In one embodiment, this method further comprises providing a third optic element and a fourth optic element and then receiving a third optic signal through a first side of the third optic element. Then reflecting the third optic signal through a third coating toward the fourth optic element and receiving a fourth optic signal through a first side of the fourth optic element. The third coating is between the third optic element and the fourth optic element. Next, this embodiment of the method receives the first optic signal, second optic signal and third optic signal through a second side of the fourth optic element, and reflects the first optic signal, second optic signal and fourth optic signal from a fourth coating while allowing the fourth optic signal to pass through the fourth coating. This has the effect, due to optic signal (beam) alignment of combining the first optic signal, the second optic signal, the third optic signal and the fourth optic signal into a combined optic signal. The combined optic signal is output from the third optic element.

It is contemplated that the coating may be a deposition coating. In one variation, this method further comprises presenting the combined optic signal to a lens which focuses the optic combined optic signal into fiber optic cable. The coatings may be configured to pass one or more first energy wavelengths and reflect one or more second energy wavelengths. In one embodiment, the one or more first coatings result in a high reflective coating and the one or more second coatings result in a low wavelength pass coating in which all frequencies of the first optic signal pass through the one or more first coatings while reflecting frequencies that have a wavelength higher than the first optic signal.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A illustrates a prior art optical transmitter with associated fiber optic cable.

FIG. 1B illustrates a prior art optical multiplexer configuration.

FIG. 2 is a block diagram illustrating the improved optical multiplexer in an optic module.

FIG. 3 is a block diagram illustrating the improved optical multiplexer in an optic module.

FIG. 4 illustrates an example embodiment of an optical multiplexer.

FIG. 5 illustrates an expanded view of the optical multiplexer with additional information regarding interface coating.

### DETAILED DESCRIPTION

To overcome the drawbacks of the prior art and provide additional benefit, an improved optical multiplexer (OMUX) is disclosed. As shown in FIG. 2, the disclosed OMUX is much smaller in size, such as only 4 mm by 1 mm, than the prior art thereby allowing the module, such as for example the entire TOSA module, to be only about 7.7 mm in length. The measurement are approximations and provide only to aid understanding and described the benefits over the prior art. This can, in some devices, result in a TOSA module size reduction of 50% or more and an OMUX size reduction of 80% in some systems. This is a significant reduction in size as compared to prior art OMUX and associated modules. Although shown as a TOSA (transmitting optical sub-assembly), it is contemplated that this innovation may be used in any optical environment including any optical sub-assembly.

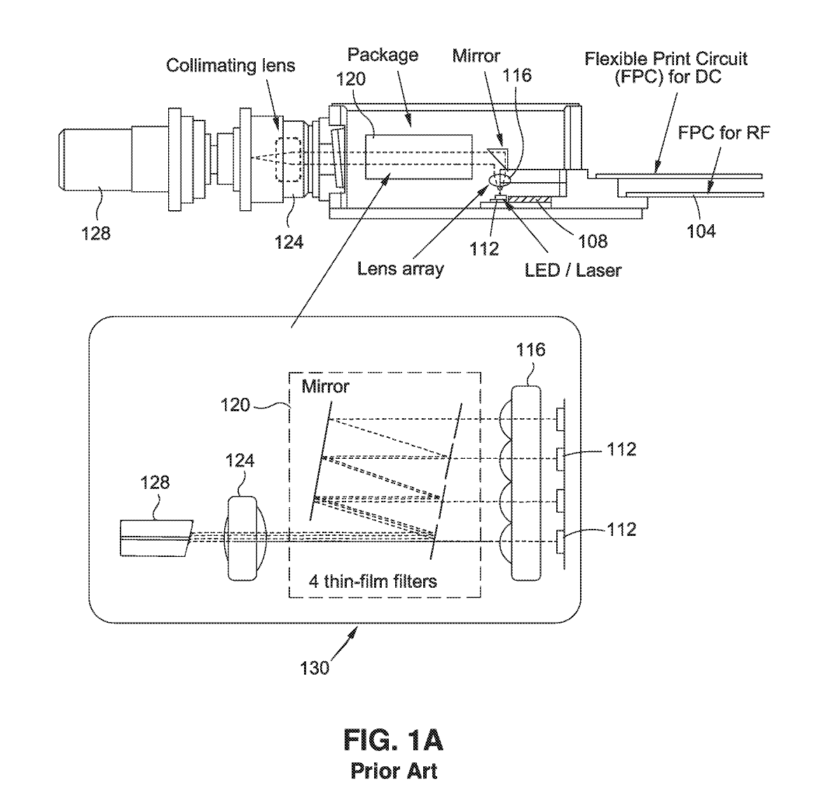

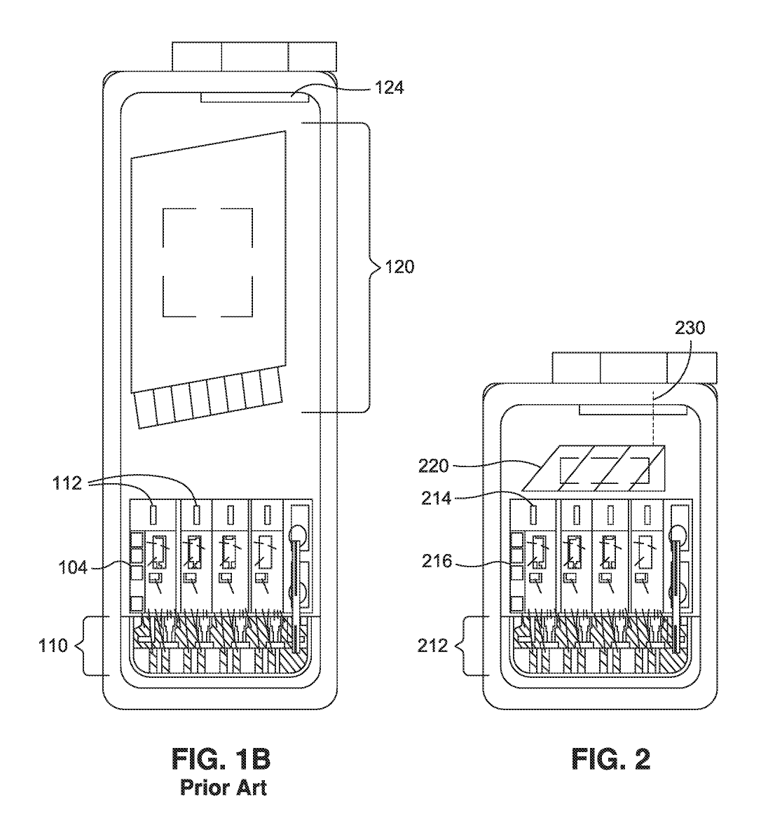

The OMUX shown in FIG. 2 may be utilized in the example environment of FIG. 1A by replacing the OMUX 120 with the OMUX shown in FIG. 2. As shown in FIG. 2, the module 208 has electrical connectors 212 that convey the electrical signals, such as high-speed RF signals, to the electronics 216 of module. One or more LEDs or lasers 214 receive the electrical signals and generate the two or more optic signals, based on the two or more electrical signals. The two or more optical signals are provided to the OMUX 220 which is configured according to the disclosure below. The output of the module 208 is one or more optic signals 230 formed by combining, in the OMUX 220, the optic signals into a fewer number of optic signals. The OMUX 220 is formed from two or more glass parallelograms (OMUX elements) which are glued together with wavelength specific filter coatings on or in the transitions between the parallelograms. In one or more other embodiments, the OMUX elements are connected or attached by glue, optical adhesive or any means of adhering connecting elements with intended optical filtering or transparency or any other type adhesive or connecting members. The filters could also be manufactured into the optic element such that instead of multiple optic elements which are then attached, a single optic element may be used with built in filter elements. It is also contemplated that the OMUX elements may be a shape other than parallelograms, such that the optic path and reflections are established as shown, described or claimed herein. In addition to reduced size, there is a further benefit of lower heat dissipation, less costly design to implement, and more accurate resulting combined optic signal.

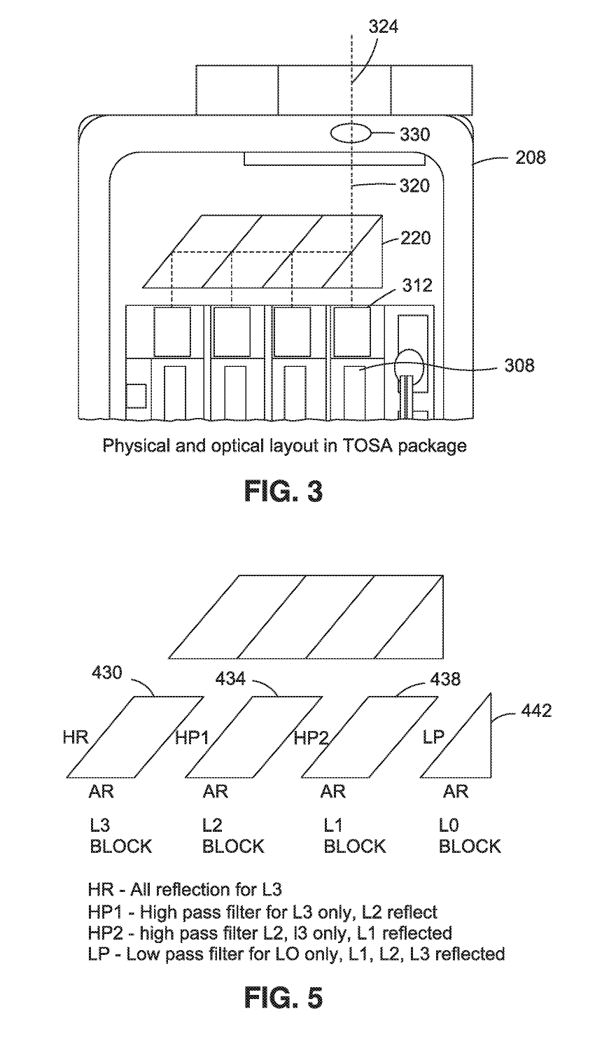

FIG. 3 illustrates an example embodiment of the improved optical multiplexer. As shown, the laser or LED (light source) 308 outputs an optic signal. In this embodiment, there are four channels and thus four light sources 308 collimated as shown. The optic signals generated by the light sources 308 are directed by a lens 312 toward the optical multiplexer (OMUX) 220. The OMUX 220 combines the four individual optic signals using reflection combination into a single optic signal 320 which is provided to the fiber 324. One or more lenses 330 focus the optic signal to the fiber 324. In various embodiments the two or more different wavelengths of light may be collimated and the wavelengths can be of ascending/descending/mixed order such that the behavior of the coating(s) is matched to the wavelengths and multiplexer function.

The basic concept of the improved OMUX 220 is to reduce the number of optical reflection points, reduce the optic signal path length, and reduce the OMUX size. This reduces footprint and drastically increases uniformity in optical performance along each path and uniformity from one OMUX to the next OMUX. These performance improvements include beam angle error accumulation, optical path length, optical effective aperture, and optical power loss. Reducing the number of optical reflection points also reduces footprint and drastically increase uniformity in optical performance, while also improving beam angle error accumulation, optical path length, optical effective aperture, and optical power loss. If these aspects are not consistent and optimized then the various signals with form the final combined optic signal will not be aligned and will have unwanted optical power level or quality issues.

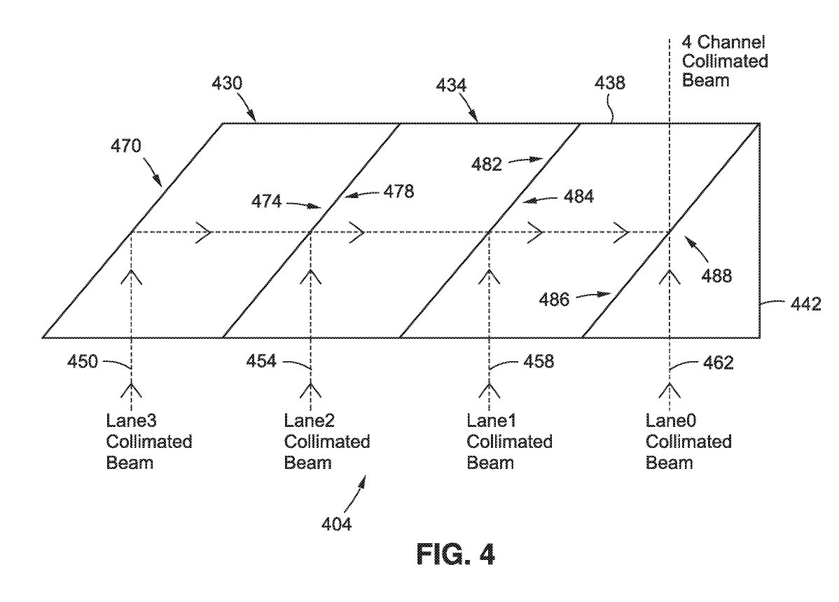

FIG. 4 illustrates an optical multiplexer. The OMUX 404 is configured to receive four optic signals, labeled as lane 3, lane 2, lane 1, and lane 0. Each optic signal is formed from light of different wavelengths. In this example embodiment, 4 lanes are shown but it is contemplated that in other embodiments a greater number than or fewer number than 4 optic signals may be used. The number of lanes may be matched to the number of optic signals present and the number of combined or collimated optic beams are desired. Shown for illustration purposes, are the light beams shown as line 3 (450), lane 2 (454), lane 1 (458), and lane 0 (462). Each lane 450, 454, 458, 462 may carry or be formed from a different wavelength as formed by the light generated by the optic signal generators. In this example embodiment, the OMUX comprises three parallelogram shaped optic elements 430, 434, 438, and one triangle shaped optic element 442. In other embodiments, other shapes may be used for the OMUX elements as the innovative aspect is not the exact shape itself, but the light reflection and light pass-through characteristic of the OMUX as described herein.

Each OMUX element is not discussed in greater detail. The lane 3 OMUX element is element 430. The lane 2 OMUX element is element 434. The lane 1 OMUX element is element 438. The lane 0 OMUX element is element 442. In some embodiments a single coating or filter layer may be placed between OMUX elements, while in other embodiments multiple coating or layers may be established. The coating function is of importance and not the number of or coatings layers. These coatings which are selected to selectively reflect and pass the optic signals in a manner which combines and passes the light beams as shown. The reflections occur at an angle of 45 degrees in relation to or incident to the coating or filter that is between adjacent elements.

To aid in understanding the following nomenclature is established. The coating on the outer edge of OMUX element 430 is coating C470. The coating on the side of OMUX element 430 that is adjacent OMUX element 434 is coating C474. The coating on the side of OMUX element 434 that is adjacent OMUX element 430 is coating C478. The coating on the side of OMUX element 434 that is adjacent OMUX element 438 is coating C482. The coating on the side of OMUX element 438 that is adjacent OMUX element 434 is coating C484. The coating on the side of OMUX element 438 that is adjacent OMUX element 442 is coating C486. The coating on the side of OMUX element 442 that is adjacent OMUX element 438 is coating C488.

At the outer left-hand edge of the lane 3 element is reflective coating 470 that is configured to reflect all of the lane 3 optic signal 450 to the right as shown. The optic coating 478 on OMUX element 430 between the lane 3 optic element 430 and the lane 2 optic element 434 is an optic coating that is a low pass filter coating that allows the lane 3 optic signal 450 to pass while reflecting the lane 2 optic signal 454 to the right as shown. This results in a combining of the lane 3 optic signal 450 and the lane 2 optic signal 454. It is contemplated that the optic signals described herein may be a beam, a collimated beam, or any other type of light or optic signal, in the visible or non-visible wavelengths.

An optic coating 482, 484 between the lane 2 optic element 434 and the lane 1 optic element 438 is an optic coating that allows the lane 3 optic signal 450 and the lane 2 optic signal 454 to pass while reflecting the lane 1 optic signal 458 to the right. This may be referred to as a low pass filter coating. An optic coating 486, 488 between the lane 1 optic element 438 and the lane 0 optic element 442 is an optic coating that reflects the lane 3 optic signal 450, the lane 2 optic signal 454, and lane 1 optic signal 458 upward while allowing the lane 0 optic signal to pass through. After the pass-through of optic signal 488 and the reflection of the other optic signal, the resulting combined optic signal is the combination of the four optics signals. This interface between the lane 1 optic element 438 and the lane 0 optic element 442 causes all four optic signals to be combined into a single optic signal directed out of the OMUX as shown.

FIG. 5 illustrates an expanded view of the optical multiplexer with additional information regarding interface coating. In this figure, the four optic elements 430, 434, 438, and 442 comprise three parallelograms and a triangle shape respectively. The four optic elements 430, 434, 438, and 442 are aligned along each optic signal path such that when the signals are combined, a single beam is formed. As shown in FIG. 5, the four optic elements 430, 434, 438, and 442 are expanded to better show the coating between each optic element. The coatings labeled as AR on the faces of the optic elements that face the light source are anti-reflective coating (AR) to allow as much light energy as possible to pass into the optic element. The AR coatings as shown in FIG. 5 minimize reflection of light from the light sources, such as light sources 312 as shown in FIG. 3. By minimizing reflection, the amount of light energy provide into the optic element eventually into the collimated beam is maximized. As shown on the left-hand side of the lane 3 optic element 430, the outer coating on lane 3 optic element reflects all light and is thus labeled with an HR designation for high reflection coating.

The interface between the lane 3 optic element 430 and the lane 2 optic element 434 is a high pass coating (HP1) designed to pass the lane 3 optic signal (L3) while reflecting the lane 2 optic signal (L2). This may be referred to as a high pass (HP) coating. The term high pass filter should not be confused with band pass filters which block wavelengths that are higher than and lower than the pass band. The use of wavelength filtering and wavelength specific reflections enables the optical reflections and signal pass scheme disclosed herein. The terms high pass and low pass are in reference to wavelengths and as such the term high pass references the coating or filter film passing high wavelengths.

The interface between the lane 2 optic element 434 and the lane 1 optic element 438 is a high pass coating HP2 designed to pass the lane 3 optic signal (L3) and the lane 2 optic signal (L2) while reflecting the lane 1 optic signal (L1). This may be referred to as a high pass (HP) coating.

The interface between the lane 1 optic element 438 and the lane 0 optic element 442 is a low pass coating (LP) and is designed to pass the lane 3 optic signal (L3), the lane 2 optic signal (L2), the lane 1 optic signal (L1), while allowing the lane 0 optic signal (L0) to pass. This may be referred to as a low pass (LP) coating. It is contemplated that the lane 3 wavelength is higher than the lane 2 wavelength, the lane 2 wavelength is higher than the lane 1 wavelength, and the lane 1 wavelength is higher than the lane 0 wavelength.

Although shown as parallelograms and a triangle, it is contemplated the optic elements 430, 434, 438, 442 may be any shape or configuration such that the overall system has a reflection surface and either low pass or high pass filter coatings that cause the two or more optic signals (beams) be combined into a reduced number of optic signals (beams). Of importance is the reflection of the signal, pass-through of a signal, and combination of the signals. For example, in one alternative embodiment and in reference to FIG. 4, the combined beam could exit the right-hand side of optic element 442 if the coating on the sides 486, 462 is configured to reflect the beam 462 and allow the combined beam from optic element 438 to pass and not be reflected. In another embodiment, the shape of the optic elements could be other than a parallelogram such that the shape of the optic element at locations other than the path of the optic signal could be altered. For example, the top side of the optic elements could be any shape since the optic signal (beam) does not pass through or near this side. Other variations in shape are contemplated. The design shown allows for duplicity in design and light path and an extended solid surface between each optic element that may be glued or otherwise attached to maintain stability over time. It also contemplated that although shown with 4 lanes, a greater or fewer number of lanes may be provided. Likewise, although shown with a single combined output beam, a greater number of output beams could be established.

The optic elements may comprise glass, plastic, plexiglass or any other material suitable for light transmission. The elements may be glued together or attached in any other manner and the coating may comprise thin film filters. To exhibit thin-film optics, the thickness of the layers of material are typically in the order of the wavelengths of visible light (about 500 nm), but other thickness may be used and other materials may use other layer thicknesses. These values are exemplary only. Layers at this scale can have good reflective properties due to light wave interference and the difference in refractive index between the layers, the air, and the substrate. These effects alter the way the optic reflects and transmits light. This effect is known as thin-film interference. In manufacturing, thin film layers can be achieved through the deposition of one or more thin layers of material onto a substrate (usually glass). This is most often done using a physical vapor deposition process, such as evaporation or sputter deposition, or a chemical process such as chemical vapor deposition, or any other layer creation process.

Table 1 provides a comparison between the improved optical multiplexer and the prior art (current) optical multiplexer. The first column provides the category of performance feature. The second column lists the prior art (current) OMUX characteristics. The third column lists the improved OMUX performance characteristics. The term L0, L1, L2, and L3 identify the lanes or optic beams. The “term eff. aperture” is defined as the ‘effective aperture.’ The claims should not be considered as being limited to these values or characteristics, but the information in Table 1 is provided to show the improvement of the claimed innovation over the prior art.

| Category | Current | New MUX |
|---|---|---|
| Footprint | >6 mm × 4 mm | <1 mm × 4 mm |
| (MUX) | 100% | ~50% |
| Footprint | | |
| (TOSA) | | |
| Optical | L0 path length = 13 mm | L0 path length ~4 mm |
| Performance | L1 path length = 32 mm | L1 path length ~5 mm |
| | L2 path length = 51 mm | L2 path length ~6 mm |
| | L3 path length = 70 mm | L3 path length ~7 mm |
| | Non-uniform focal length | Uniform focal length |
| | (creates defocus trouble at fiber assembly) | (creates ease for fiber assembly) |
| | L0 reflection points = 0 | L0 reflection points = 2 |
| | L1 reflection points = 2 | L1 reflection points = 2 |
| | L2 reflection points = 4 | L2 reflection points = 2 |
| | L3 reflection points = 6 | L3 reflection points = 2 |
| | reflection uncertainly increases at far channels | Uniform reflection uncertainly |
| | (difficulty in alignment) | (alignment difficulty uniform) |
| | L0 eff. aperture ~0.6 mm | L0 eff. aperture >0.6 mm |
| | L1 eff. aperture ~0.5 mm | L1 eff. aperture >0.6 mm |
| | L2 eff. aperture ~0.4 mm | L2 eff. aperture >0.6 mm |
| | L3 eff aperture ~0.3 mm | L3 eff aperture >0.6 mm |
| | Non-uniform effective input aperture size | Uniform effective input aperture size |
| | Optical loss non-issue | Optical loss negligible |
| Assembly | Parallel side alignment with package wall | Parallel alignment with package wall |
| | (misalignment compensated by 1^{st} lens but angled | (misalignment can be better compensated |
| | output creates difficulty at fiber coupling with | by 1^{st} lens since number of reflection |
| | reduced effective aperture) | points is only 2) |
| MUX fabrication | High Reflection side: 1 (on base block) | High Reflection side: 1 (L3 block) |
| | Anti-Reflection side: 4 + 1 (4 filters and on base) | Anti-reflection side: 4 (4 filters) |
| | L0-L3 filter coating: 4 types | L0-L3 filter coating: 3 types |
| | Adhesion areas: 4 (4 filters) | Adhesion areas: 3 (3 surfaces) |

Table 1 lists many of the advantages over the previous technology. One aspect of the performances is how far a light beam must travel in an OMUX before exiting the device. The prior art used a path that included multiple reflection points for each light beam that resulted in a long light path and many reflections and the disclosed OMUX design improves this aspect over the prior art. Shorter travel distances result in less attentions and an improved ability to properly align the light to the fiber. Long distances make alignment harder and misalignment results in alignment error. The disclosed OMUX has a much shorter path length than the prior art OMUX.

In addition, the travel distance of each beam in the disclosed OMUX differs by only a couple millimeters in length. If a beam travels longer distances, the focal length for each beam changes which disrupts operation. In addition, the disclosed OMUX has a reduced number of reflection points. For a four-channel embodiment, the maximum number of reflection points for any light beam is two, which is much fewer than the multi-reflection design prior art devices.

Also improved is the effective aperture. When a laser beam goes into filter, it has a window of effectiveness. The further a channel input is from the output, the beam would have a smaller effective aperture when output into the fiber. Thus, more adjustment is required for a prior art OMUX to move or get beam to fiber.

In addition, the disclosed OMUX has less loss. The reflection points each cause power loss, so by decreasing reflections, the power loss is reduced and alignment is easier. In addition, the disclosed innovation lowers the fabrication difficulty and the cost of the product is also lower price. Cost of production and materials is also reduced compared to the prior art because of fewer materials and ease of fabrication. In addition, optical performance is increased.

The disclosed optic beam reflection and pass/reflection approach described herein may be used in a TOSA, or ROSA, or any other element which uses an optical multiplexer. In one embodiment, the filter or coating may comprise multiple layers or different thicknesses of layers and each be formed from the same or different material.

It is also contemplated that using a similar approach, a de-multiplexer may be created such that the signal path is reversed and the coating function would separate the optic signal from a single collimated or combined beam into separate beams or signals. For example, for the de-multiplexer such as used in a ROSA, the wavelength order is the opposite. For other special cases, the wavelength orders can be different, as long as wavelengths can be filtered correctly in a same band. Hence, in one example embodiment the OMUX order is L3, L2, L1, L0 order, while for a DE-OMUX the order is L0, L1, L2, L3, and a special or alternate configuration may be ordered as L1, L2, L0, L3. In the DE-OMUX application, the incoming collimated optic signal would be separated into multiple individual optic signals but reflecting multiple wavelengths while one wavelength passed and is thus separated. Thereafter, one wavelength would be reflected out of the DE-OMUX by a coating while the remaining collimated optic signals pass through the coating.

For example, in reference to FIG. 4, if the beam direction were reversed and thus the device configured to operate as an DE-OMUX, the incoming beam (4 channel collimated beam) would enter the DE-OMUX from the top (reverse direction) and strike the one or more coatings 486, 488. The coatings may be different from the OMUX configuration due to the need to separate the beams instead of combining the beams. The lane 0 beam 463 would pass through the one or more coatings 486, 488. Lanes 1, 2, and 3 beams 458, 454, 450 would be reflected to the left for this DE-OMUX configuration. Thus, the one or more coatings 486, 488 are configured to pass beam 462 wavelengths and reflect beams 458, 454, 450 wavelengths. The one or more coatings 482, 484 are configured to reflect beam 458 wavelengths while allowing beam 454, 450 wavelengths to pass through. Thus, beam 458 is separated and output from the bottom of the DE-OMUX. The one or more coatings 474, 478 are configured to reflect beam 454 wavelengths while allowing beam 450 wavelengths to pass through. Thus, beam 454 is separated and output from the bottom of the DE-OMUX. The one or more coatings 470 are configured reflect the final beam 450 wavelengths thereby causing the beam 450 to exit the DE-OMUX. The DE-OMUX can be configured with any number of channels, either greater or fewer than four. The coatings may be different from the OMUX configuration due to the intent to separate the beams instead of combining the beams. Although shown in some instances as two coatings, there may be only one coating or filter between the optic elements. The separated optic signal may be provided to a photodiode or other element which converts the optic signals to electrical signals.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An optical multiplexer comprising:
a first optic element configured to receive a first optic signal;
a first filter on the first optic element configured to reflect the first optic signal;
a second optic element configured to receive a second optic signal;
a second filter between the first optic element and the second optic element, the second coating configured to allow the first optic signal to pass the while reflecting the second optic signal;
a third optic element configured to receive a third optic signal;
a third filter between the second optic element and the third optic element, the third filter configured to allow the first optic signal and the second optic signal to pass while reflecting the third optic signal;
a fourth optic element configured to receive a fourth optic signal; and
a fourth filter between the third optic element and the fourth optic element, the fourth filter configured to allow the fourth optic signal to pass while reflecting the first optic signal, second optic signal, and third optic signal.

2. The multiplexer of claim 1, wherein the optic elements are glass and the first optic element is adjacent the second optic element, the second optic element is

3. The multiplexer of claim 1, wherein the first filter, second filter, and third filter are configured to reflect the respective first optic signal, second optic signal and third optic signal at 45 degrees relative to the reflecting filter.

4. The multiplexer of claim 1, wherein the first filter, second filter, third filter and fourth filter are wavelength specific filters which are configured to pass certain light and reflect other wavelengths.

5. The multiplexer of claim 1, wherein the fourth optic element and fourth filter combine the first optic signal, second optic signal and third optic signal, and fourth optic signal into a combined optic signal which exits the fourth optic element.

6. The multiplexer of claim 1, wherein the first optic element, the second optic element and the third optic element are parallelogram shaped and the fourth optic element is a triangle shape.

7. An optical multiplexer comprising:
a first optic element configured to receive a first optic signal;
one or more first coatings on in the path of the first optic signal, the one or more first coatings configured to reflect the first optic signal;
a second optic element configured to receive a second optic signal and the first optic signal; and
one or more second coatings between the first optic element and the second optic element, the one or more second coatings configured to allow the first optic signal to pass therethrough the while reflecting the second optic signal such that the first optic signal and the second optic signal overlap to create a combined optic signal.

8. The optical multiplexer of claim 7, further comprising a third optic element configured to receive a third optic signal;
a one or more third coatings between the second optic element and the third optic element, the one or more third coatings configured to allow the first optic signal and the second optic signal to pass therethrough, while reflecting the third optic signal such that the first optic signal, the second optic signal, and the third optic signal overlap to create the combined optic signal.

9. The optical multiplexer of claim 8, further comprising
an additional optic element configured to receive an additional optic signal; and
a one or more additional coatings between the third optic element and the additional optic element, the one or more additional coatings configured to allow the additional optic signal to pass while reflecting the first, second, and third optic signals such that the first optic signal, the second optic signal, the third optic signal, and the additional optic signal overlap to create the combined optic signal.

10. The optical multiplexer of claim 9, wherein reflecting first, second, and third optic signals reflects the first, second, and third optic signals at 45 degrees relative to a reflecting filter.

11. The optical multiplexer of claim 7, wherein the one or more first coatings are a reflective type coating, and the second coating is a reflective and pass type coating.

12. The optical multiplexer of claim 7, wherein the optic elements are formed from glass.

13. The optical multiplexer of claim 7, wherein the one or more first coatings reflects the first optic signal at a 45 degree angle with respect to the one or more first coatings.

14. The optical multiplexer of claim 7, further comprising a fiber optic cable configured to receive the combined signal, and one or more optic signal generators configured to generate the first optic signal and the second optic signal.

15. A method for performing optical multiplexing comprising:
providing a first optic element and a second optic element;
receiving a first optic signal through a first side of the first optic element;
reflecting the first optic signal from a coating toward the second optic element;
receiving a second optic signal through a first side of the second optic element;
receiving the first optic signal through a second side of the second optic element; and
reflecting the second optic signal from a second coating while allowing the first optic signal to pass through the second coating into the second optic element to thereby combine the first optic signal and the and the second optic signal into a combined optic signal.

16. The method of claim 15 further comprising:
providing a third optic element and a fourth optic element;
receiving a third optic signal through a first side of the third optic element;
reflecting the third optic signal from third coating toward the fourth optic element;
receiving a fourth optic signal through a first side of the fourth optic element;
receiving the first optic signal, second optic signal and third optic signal through a second side of the fourth optic element;
reflecting the first optic signal, second optic signal and fourth optic signal from a fourth coating while allowing the fourth optic signal to pass through the fourth coating to thereby combine the first optic signal, the second optic signal, the third optic signal and the fourth optic signal into a combined optic signal; and
outputting the combined optic signal from the third optic element.

17. The method of claim 15, the coating is a deposition coating.

18. The method of claim 15, further comprising presenting the combined optic signal to a lens which focuses the optic combined optic signal into fiber optic cable.

19. The method of claim 15 wherein the coating is configured to pass one or more first energy wavelengths and reflect one or more second energy wavelengths.

20. The method of claim 15 wherein the first coating is a reflective coating and the second coating is a coatings which passes certain wavelengths and reflects certain wavelengths.

21. An optical multiplexer for use in an optic communication module comprising:
a first optic filter configured to receive and reflect a first optic signal; and
a second optic filter configured to receive the reflected first optic signal and receive a second optic signal such that the second optic filter is configured to allow the reflected first optic signal to pass through while reflecting the second optic signal to thereby combine the reflected first optic signal and the reflected second optic signal to create a combined optic signal.

22. The optical multiplex of claim 21 further comprising:
a third optic filter configured to receive the reflected first optic signal, the reflected second optic signal and further receive a third optic signal such that the third optic filter is configured to allow the reflected first optic signal and the reflected second signal to pass through while reflecting the third optic signal to thereby combine the reflected first optic signal, the reflected second optic signal, and the reflected third optic signal; and
a fourth optic filter configured to receive the reflected first optic signal, the reflected second optic signal, the reflected third optic signal and further receive a fourth optic signal such that the fourth optic filter is configured to reflect the reflected first optic signal, the reflected second signal, and the reflected third optics while allowing the fourth optic signal to pass thereby combining the reflected first optic signal, the reflected second optic signal, the reflected third optic signal, and the fourth optic signal.

23. The optical multiplex of claim 21, wherein the optic filters are on a substrate.
